(19) United States
(12) Patent Application Publication
(10) Pub. No.: US 2010/0253646 A1
(43) Pub. Date: Oct. 7, 2010

(54) POSITION INPUT DEVICE

(75) Inventor: Kazuyuki HIRATSUKA, Kyoto-shi (JP)

Correspondence Address: HAMRE, SCHUMANN, MUELLER & LARSON, P.C., P.O. BOX 2902, MINNEAPOLIS, MN, 55402-0902, US

(73) Assignee: ROHM CO., LTD., Kyoto-shi (JP)

(21) Appl. No.: 12/683,854

(22) Filed: Jan. 7, 2010

(30) Foreign Application Priority Data
Jan. 9, 2009 (JP) 2009-003319
Feb. 19, 2009 (JP) 2009-036515

(51) Int. Cl. G06F 3/041

(52) U.S. Cl. 345/174

(57) ABSTRACT

An input device includes a base plate having a front surface and a rear surface, and a plurality of first electrodes formed on the front surface of the base plate and parallel to each other, where each of the first electrodes includes a plurality of first electrode elements arranged in a first direction. The input device also includes a plurality of second electrodes formed on the front surface of the base plate and parallel to each other, where each of the second electrodes includes a plurality of second electrode elements arranged in a second direction different from the first direction. Further, a controller is provided for detection of a conductor approaching the first electrodes and the second electrodes in a thickness direction of the base plate. The controller is configured to detect an access position of the conductor with respect to the first direction and the second direction based on a capacitance change in the first electrodes and the second electrodes. The base plate is formed with a plurality of first wiring elements each connecting the first electrode elements of a corresponding one of the first electrodes. One of the first wiring elements is formed in a first gap flanked by adjacent ones of the first electrode elements and the second electrode elements.

### BACKGROUND OF THE INVENTION

1. Field of the Invention

The present invention relates to a position input device used for a touch panel, for example.

2. Description of the Related Art

Conventionally, touch panels (or touch screens) have been widely used for e.g. automatic teller machines (ATMs) in banks, automatic ticket machines in rail stations, or digital information devices such as cellular phones. A touch panel is made up of an image display device (e.g. liquid crystal panel) and a position input device. Position input devices (referred to as “input devices” below) vary in operating principle. For instance, an input device used for a cellular phone may be configured as a capacitance type device. Preferably, an input device used for a small gadget such as a cellular phone should be as thin as possible.

A conventional method for reducing the thickness of a capacitance type input device is disclosed in Japanese Utility Model Registration No. 3144241. As illustrated in FIGS. 16 and 17 of the present application, the conventional input device of the above-identified registration includes first electrodes 93 and second electrodes 94 formed in a mutually crossing manner on a single transmitting plate 91. Each of the first electrodes 93 is composed of a plurality of electrode elements 931 connected to each other by wiring 95, and each of the second electrodes 94 is composed of a plurality of electrode elements 941 connected to each other by wiring 96. An insulating member 98 is provided at the cross portion of the wirings 95 and 96 so as to electrically separate the wirings 95, 96 from each other.

With the above arrangement, only one transmitting plate is used, and thus, the input device as a whole can be made thinner than when use is made of separate transmitting plates for the first electrodes 93 and the second electrodes 94, respectively. The prior art technique, however, may have the following problems.

First, as shown in FIG. 16, insulating members 98 need to be formed at a plurality of locations. Accordingly, the manufacturing process tends to be complicated and time-consuming, thereby lowering the production efficiency. Second, as shown in FIG. 17, the wiring 96 is connected to the electrode elements 941 only at its ends, which is because the wiring 96 is formed into an arch due to the underlying insulating member 98. In this condition, however, the wiring 96 can be readily detached from the electrode elements 94 when an external force is applied on the wiring 96, thereby breaking the required electrical connection.

### SUMMARY OF THE INVENTION

The present invention has been proposed under the circumstances described above. It is therefore an object of the present invention to provide a capacitance type input device that can be manufactured in simplified processes and is not prone to wiring breakage due to external force.

According to a first aspect of the present invention, there is provided an input device comprising: a base plate including a front surface and a rear surface; a plurality of first electrodes formed on the front surface of the base plate and parallel to each other, each of the first electrodes including a plurality of first electrode elements arranged in a first direction; a plurality of second electrodes formed on the front surface of the base plate and parallel to each other, each of the second electrodes including a plurality of second electrode elements arranged in a second direction different from the first direction; a controller for detection of a conductor approaching the first electrodes and the second electrodes in a thickness direction of the base plate, the controller being configured to detect an access position of the conductor with respect to the first direction and the second direction based on a capacitance change in the first electrodes and the second electrodes; and a plurality of first wiring elements each connecting the first electrode elements of a corresponding one of the first electrodes. One of the first wiring elements is formed in a first gap flanked by adjacent ones of the first electrode elements and the second electrode elements.

According to a second aspect of the present invention, there is provided an input device comprising: a base plate including a front surface and a rear surface; a plurality of first electrodes formed on the front surface of the base plate and parallel to each other, each of the first electrodes including a plurality of first electrode elements arranged in a first direction; a plurality of second electrodes formed on the front surface of the base plate and parallel to each other, each of the second electrodes including a plurality of second electrode elements arranged in a second direction different from the first direction; a controller for detection of a conductor approaching the first electrodes and the second electrodes in a thickness direction of the base plate, the controller being configured to detect an access position of the conductor with respect to the first direction and the second direction based on a capacitance change in the first electrodes and the second electrodes; a plurality of first wiring elements each connecting the first electrode elements of a corresponding one of the first electrode; and a plurality of second wiring elements each connecting the second electrode elements of a corresponding one of the second electrodes. The second wiring elements are stacked on the first wiring elements or the first electrodes with an insulating layer intervening therebetween, and the second wiring elements include connecting portions provided on the second electrode elements and extending in the second direction.

According to a third aspect of the present invention, there is provided an input device comprising: a base plate including a front surface and a rear surface; a plurality of first electrodes formed on the front surface of the base plate and parallel to each other, each of the first electrodes including a plurality of first electrode elements arranged in a first direction; a plurality of second electrodes formed on the front surface of the base plate and parallel to each other, each of the second electrodes including a plurality of second electrode elements arranged in a second direction different from the first direction; a controller for detection of a conductor approaching the first electrodes and the second electrodes in a thickness direction of the base plate, the controller being configured to detect an access position of the conductor with respect to the first direction and the second direction based on a capacitance change in the first electrodes and the second electrodes; first wiring made of a metal and connecting two adjacent ones of the first electrode elements in the first direction and formed in gaps between the first electrode elements; and second wiring stacked on the first wiring at a side opposite to the base plate and connecting two adjacent ones of the second electrode elements in the second direction, the second wiring being formed in gaps between the second electrode elements.

Other features and advantages of the present invention will become more apparent from the detailed description given below with reference to the accompanying drawings.

### BRIEF DESCRIPTION OF THE DRAWINGS

FIG. 1 is a partial cross-sectional view of an input device according to a first embodiment of the present invention;

FIG. 2 is a plan view along line II-II in FIG. 1;

FIG. 3 is a plan view of an input device according to a second embodiment of the present invention;

FIG. 4 is a plan view of an input device according to a third embodiment of the present invention;

FIG. 5 is a plan view of an input device according to a fourth embodiment of the present invention;

FIG. 6A is an enlarged view of region Ra in FIG. 5;

FIG. 6B is an enlarged view of region Rb of FIG. 5;

FIG. 7 is a plan view of an input device according to a fifth embodiment of the present invention;

FIG. 8 is a plan view of an input device according to a sixth embodiment of the present invention;

FIG. 9 is a plan view of an input device according to a seventh embodiment of the present invention;

FIG. 10 is a plan view of an input device according to an eighth embodiment of the present invention;

FIG. 11 is a partial cross-sectional view of an input device according to a ninth embodiment of the present invention;

FIG. 12 is a plan view along line XII-XII in FIG. 11;

FIG. 13 is a cross-sectional view along line XIII-XIII in FIG. 12;

FIG. 14 is a partial cross-sectional view of an input device according to a tenth embodiment of the present invention;

FIG. 15 is a plan view along line XV-XV in FIG. 14;

FIG. 16 is a partial plan view of a conventional input device; and

FIG. 17 is a partial cross-sectional view of the input device of FIG. 16.

### DESCRIPTION OF THE PREFERRED EMBODIMENTS

Preferred embodiments of the present invention are explained in detail below with reference to accompanying drawings.

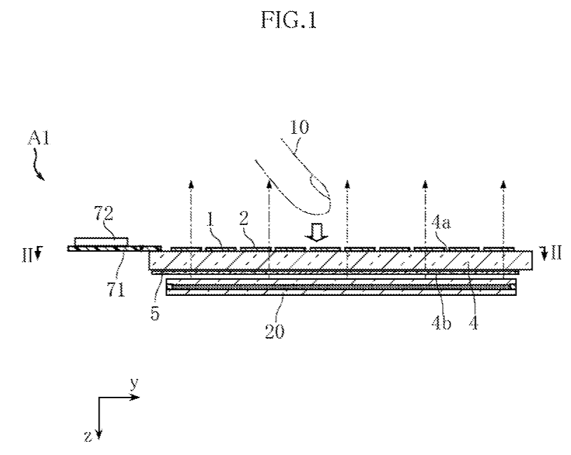

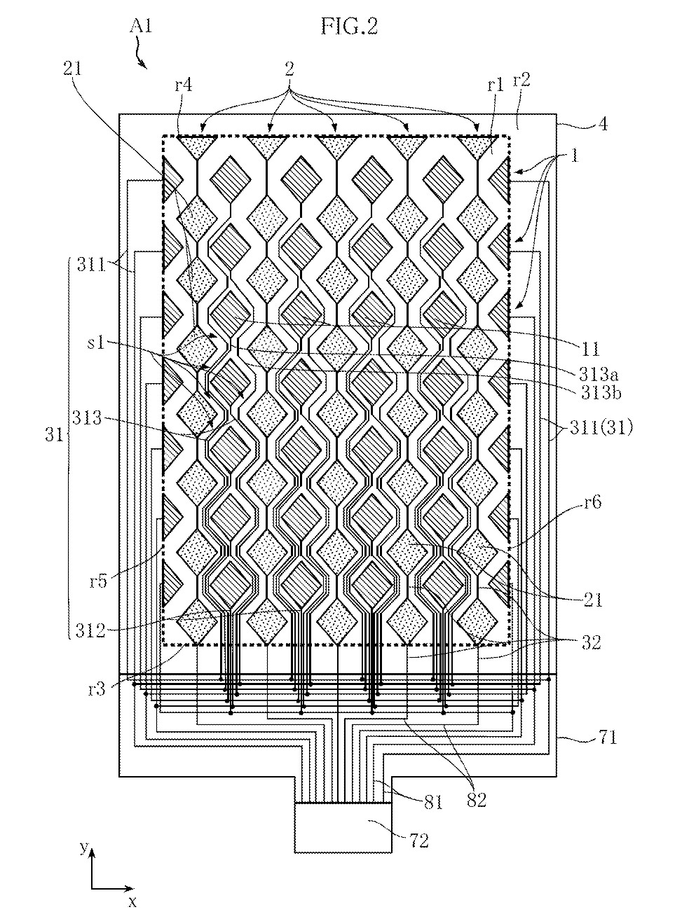

FIGS. 1 and 2 show a capacitance type position input device according to a first embodiment of the present invention. The input device A1 illustrated in the figures comprises a transmitting plate 4, a shield layer 5, a flexible board 71 and an IC chip 72. As explained below, the input device A1 is configured to detect the approach of a finger (conductor) 10 through a capacitance change. The input device A1 is stacked on a liquid crystal panel 20 to provide a touch panel (touch screen).

The transmitting plate 4 includes a flat front surface 4a and a rear surface 4b parallel to the front surface 4a. As shown in FIG. 2, the front surface 4a of the transmitting plate 4 is formed with a plurality of first electrodes 1 for detection of the finger 10 in the y direction, and a plurality of second electrodes 2 for detection of the finger 10 in the x direction (which is perpendicular to the y direction). Each of the first electrodes 1 is composed of a plurality (six in the illustrated example) of electrode elements 11 (hatched parts) arranged in line extending in the x direction. The electrode elements 11 at the respective ends are triangular, while the remaining electrode elements 11 are rhombic. In any one of the first electrodes 1, all the constituent electrode elements 11 are connected to each other by prescribed wiring (to be described later). On the other hand, the electrode elements 11 of each first electrode 1 are electrically separated from the electrode elements 11 of the other first electrodes 1. For example, referring to FIG. 2, the electrode elements 11 of the first electrode 1 closest to a dotted line r4 (to be described later) are electrically disconnected from any one of the electrode elements 11 of the other first electrodes 1.

Likewise, each of the second electrodes 2 is composed of a plurality (eight in the illustrated example) of electrode elements 21 (dotted parts) arranged in line extending in the y direction. The uppermost electrode element 21 is triangular, while the remaining electrode elements 21 are rhombic. In any one of the second electrodes 2, all the constituent electrode elements 21 are connected to each other by prescribed wiring (to be described later), while the electrode elements 21 of each second electrode 2 are electrically separated from the electrode elements 21 of the other second electrodes 2.

As shown in FIG. 2, the rectangular region surrounded by dotted lines on the transmitting plate 4 is a detection region r1 for detecting the finger 10. In the detection region r1, the above-noted electrode elements 11 and 21 are arranged in a gridlike pattern, where any one of the rhombic electrode elements 11 are surrounded by four adjacent electrode elements 21.

On the transmitting plate 4, there is a frame-like non-detection region r2 outside of the detection region r1. The boundary lines (four sides of the rectangle) between the detection region r1 and the non-detection region r2 are indicated by signs r3 through r6. In the example illustrated in FIG. 2, the boundary lines r3 and r4 correspond to the short sides of the triangle, while the boundary lines r5 and r6 correspond to the long sides of the triangle.

The transmitting plate 4 is a single-layer body made of a transparent resin or glass, where examples of transparent resin are polyethylene terephthalate (PET), polyethylene naphthalate (PEN), and polycarbonate (PC). Alternatively, the transmitting plate 4 may be configured as a laminated body made up of a plurality of layers. In this case, the respective layers may be made of different kinds of transparent resin.

A flexible board 71 is provided at an end of the front surface 4a of the transmitting plate 4. The flexible board 71 may be a multilayer substrate made up of a plurality of plates.

As explained above, most of the electrode elements 11 and 21 are rhombic, while the electrode elements 11 arranged along the boundary line r5 or r6 are triangular, and the electrode elements 21 arranged along the boundary line r4 are also triangular. Alternatively, all the electrode elements 11, 21 may be made into different forms, e.g. a circle or an n-sided polygon (n is an integer equal to or greater than five). The electrode elements 11 and 21 are formed of a transparent electroconductive material. Specifically, a thin film of e.g. ITO (Indium Tin Oxide) or IZO (Indium Zinc Oxide) is formed on the front surface 4a of the transmitting plate 4, and the resulting film is subjected to a patterning process to produce the desired electrode elements 11 and 21. Any adjacent electrode elements 11 and 21 are spaced away from each other by a prescribed distance so as to leave a gap s1 between them.

The front surface 4a of the transmitting plate 4 is formed with wiring 31 connected to the first electrodes 1 (and hence the electrode elements 11), and wiring 32 connected to the second electrodes 2 (and hence the electrode elements 21)

The wiring 31 is made of a transparent conductive material such as ITO or IZO, for example. As shown in FIG. 2, the wiring 31 includes a plurality of line elements 311, 312 and 313. Each of the line elements has a width of 30 to 100 for example.

The line elements 311 are formed in the non-detection region r2, and extend downward (in the y direction; toward the flexible board 71) along the boundary line r5 or r6. Each of the line elements 311 is to a corresponding one of the triangular electrode elements 11 (the leftmost or rightmost electrode element 11 of each first electrode 1).

Each of the line elements 312 is connected to a corresponding one of the lowermost rhombic electrode elements 11 in FIG. 2 (in other words, the rhombic electrode elements 11 which are the closest to the boundary line r3). Each of the line elements 312 extends downward from the corresponding electrode element 11 (in other words, from within the detection region r1 onto the non-detection region r2, crossing the boundary, line r3).

Each of the line elements 313 is connected to a corresponding one of the remaining rhombic electrode elements 11 other than the'above-mentioned lowermost rhombic electrode elements 11. Each line element 313 extends downward (from within the detection region r1 onto the non-detection region r2, crossing the boundary line r3) from the corresponding electrode element 11 in a manner passing through a plurality of gaps s1. The line elements 313 connected to any two electrode elements 11 that are adjacent in the y direction (see, for instance, the line elements 313a and 313b) are configured to pass through mutually different series of gaps s1.

The wiring 32 is made up of line elements for connecting the electrode elements 21 in each second electrode 2. Specifically, the wiring 32 includes a first group of line elements (“non-detection region line elements”) extending downward from the lowermost electrode elements 21 in FIG. 2 (see the five electrode elements 21 arranged along the boundary line r3), and a second group of line elements (“detection region line elements”) formed between any two electrode elements 21 that are adjacent in the y direction.

As shown in FIG. 2, the flexible board 71 is formed with first auxiliary wiring 81 connected to the wiring 31, and second auxiliary wiring 82 connected to the wiring 32.

The first auxiliary wiring 81 includes a plurality of line elements, each of which is connected to prescribed line elements of the wiring 31 so as to mutually connect the electrode elements 11 of one first electrode 1. For example, the rightmost line element of the auxiliary wiring 81 is configured to mutually connect the uppermost electrode elements 11 (the six electrode elements 11 closest to the boundary line r4) by being connected to the line elements 311 or 313 extending from the uppermost electrode elements 11, respectively.

The second auxiliary wiring 82 includes a plurality of line elements, each of which is connected to a corresponding one of the non-detection region line elements extending from the second electrodes 2.

The above-noted first electrodes 1, second electrodes 2, wiring 31 and wiring 32 are covered by a front protective layer (not shown). The front protective layer protects these electrodes and wirings against damage, and also prevents the deterioration of image visibility of the touch panel that would otherwise occur due to external light.

As shown in FIG. 1, the shield layer 5 is formed on the rear surface 4b of the transmitting plate 4, and made of a transparent conductive material such as ITO or IZO, for example. The shield layer 5 is covered by a rear protective layer (not shown). The shield layer 5 is configured to shield noise from the liquid crystal panel 20. According to the present invention, however, such a shield layer may not be provided on the rear surface 4b of the transmitting plate 4.

The IC chip 72 is connected to the first and second electrodes 1, 2 via the auxiliary wirings 81, 82. The IC chip 72 is configured to perform constant detection of the change in capacitance between the finger 10 and the first electrodes 1, while also performing constant detection of the change in capacitance between the finger 10 and the second electrodes 2, where the two detections can be performed independently of each other. The IC chip 72 may be mounted on the transmitting plate 4.

The liquid crystal panel 20 comprises a transparent substrate and a TFT (Thin Film Transistor) substrate facing each other, with a liquid crystal layer sandwiched between them, and is configured to display, for instance, an operation menu screen appearing with icons relating to various operational functions of a cellular phone. The images displayed on the liquid crystal panel 20 are visible through the input device A1. As viewed in the z direction (see FIG. 1), the image display area of the liquid crystal panel 20 generally corresponds in size and position to the detection region r1.

The touch panel, comprising the input device A1 and the liquid crystal panel 20, may be incorporated in a cellular phone, for example, and can be used in the following manner.

For instance, the liquid crystal panel 20 displays an operation menu screen including icons relating to the operational functions of the cellular phone. When no operation is made by the user (that is, when the finger 10 is well spaced from the input device A1), substantially no capacitance is produced between the finger 10 and the first electrodes 1 or the second electrodes 2. Then, when the user brings the finger 10 closer to the front surface 4a of the transmitting plate 4 so as to touch desired one of the icons, the distance between the finger 10 and the first and second electrodes 1, 2 becomes smaller. Accordingly, some capacitance is produced between the finger 10 and the electrodes 1, 2. A smaller distance between the finger 10 and the respective first electrodes 1 corresponds to a greater capacitance. Thus, by comparing the capacitances produced between the finger 10 and the respective first electrodes 1, it is possible to determine the position of the finger 10 in the direction in which the plurality of first electrodes 1 are spaced from each other (in FIG. 2, the y direction). Likewise, by comparing the capacitances produced between the finger 10 and the respective second electrodes 2, it is possible to determine the position of the finger 10 in the direction in which the plurality of second electrodes 2 are spaced from each other (the x direction). Through these determinations, the position of the finger 10 with respect to the x-y plane can be determined, thereby identifying the icon the user has touched or wishes to touch. Thereafter, in the cellular phone, the function relating to the specific icon will be activated.

The technical advantages of the input device A1 will be described below.

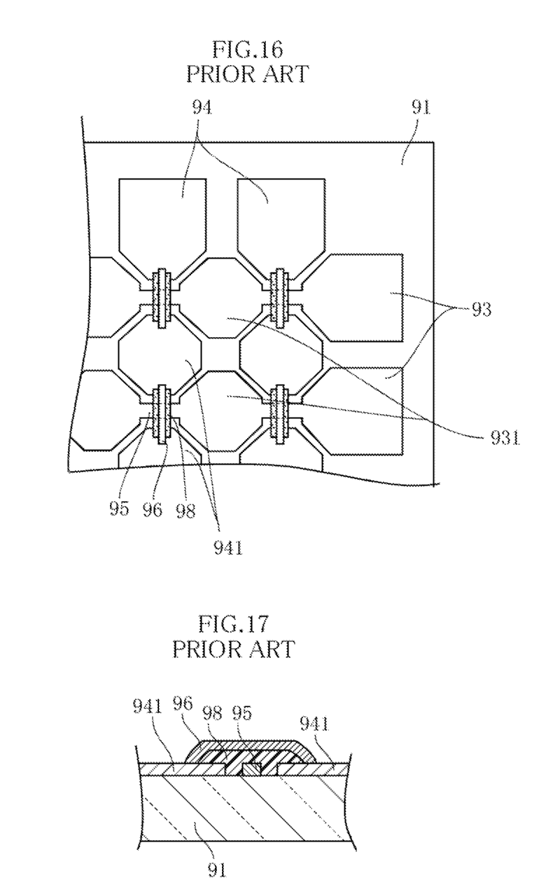

As noted above, the wiring 31 (the line elements 311, 312 and 313) and the wiring 32 (the detection region line elements and the non-detection region line elements) are, as a whole, formed on a common flat plane (the front surface 4a of the transmitting plate 4), but in spite of this, there is no crossing part between these wirings. Thus, no insulating members like the conventional ones (see reference 98 in FIG. 16) need to be formed, whereby the manufacturing process of the input device A1 can be simplified. Further, since the wirings 31, 32 do not cross, an external force inflicted part of these wirings is not readily broken.

In the input device A1, the wiring 31 includes parts (line elements 313) that extend from two electrode elements 11 adjacent in the y direction so as to pass through mutually different series of gaps s1. In this manner, it is possible to reduce the number of line elements 313 formed in each gap s1, and hence the size of the gap s1. As a result, the total area which the first and second electrodes 1, 2 occupy in the detection region r1 can be greater, which is advantageous to improving the sensitivity of the input device A1.

The first electrodes 1, second electrodes 2 and wirings 31, 32 may be made of the same material. In this case, the electrodes and wirings can be formed collectively in the same process. Accordingly, the manufacturing process of the input device A1 can be further simplified, and the production efficiently can be improved.

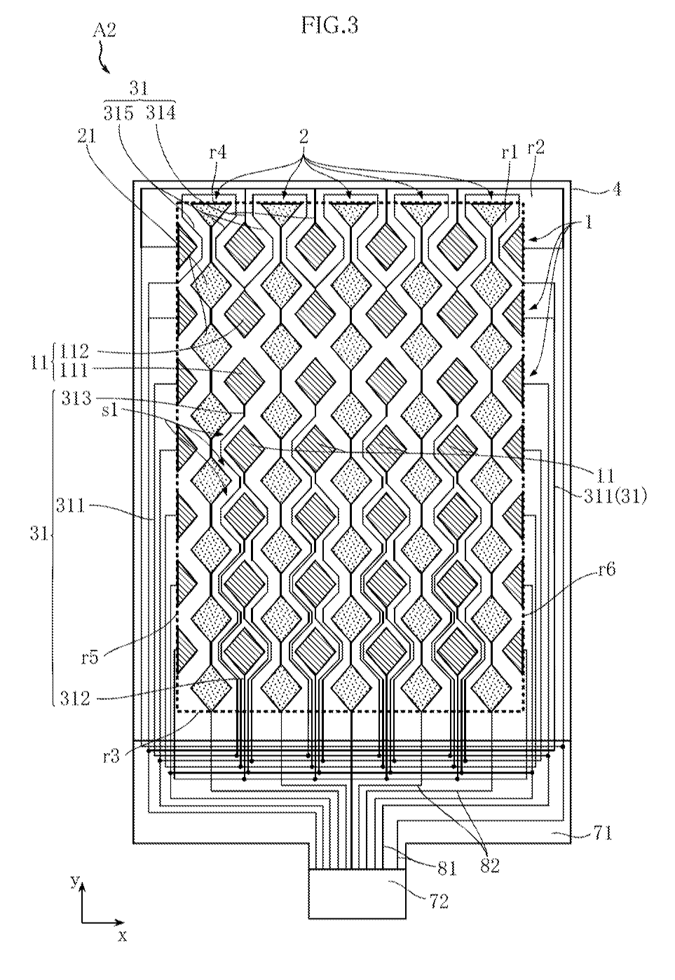

FIG. 3 illustrates an input device A2 according to a second embodiment of the present invention. In this and following embodiments, elements identical or similar to those of the first embodiment are indicated by the same reference numerals, and detailed accounts about them may not be given below. The arrangements of the input device A2 are generally the same as those of the input device A1 except for the following features.

In the input device A2, the wiring 31 also includes a plurality of line elements 314 connected to the rhombic electrode elements 11 in the row which is the closest to the boundary line r4. Each of the line elements 314 extends upward from a corresponding one of the above-mentioned electrode elements 11, crossing the boundary line r4 and onto the non-detection region r2 where the line elements 314 are connected to each other. In addition, the line elements 314 are connected to the rightmost and leftmost triangular electrode elements 11.

The wiring 31 further includes a plurality of line elements 315 connected to the rhombic electrode elements 11 (electrode elements 112) in the row which is the second closest to the boundary line r4. Each of these electrode elements 11 is connected to two line elements 315 extending upward from the element 11 in a manner bifurcating and flanking a corresponding one of the electrode element 11 (belonging to the row which is the closest to the boundary line r4), and finally reaching the non-detection region r2. Likewise of the above-noted line elements 314, any pair of bifurcating line elements 315 is connected, in the non-detection region r2, to the other pairs of bifurcating line elements 315, and also to the rightmost and leftmost triangular electrode elements 11. It should be noted here that the line elements 313, connected to the rhombic electrode elements 11 (electrode elements 111) in the row which is the third closest to the boundary line r4, are configured to extend downward (toward the boundary line r3). Thus, in the input device A2, the line element 313 and the line element 315 connected respectively to the two electrode elements 111, 112 adjacent in the y direction, extend oppositely from each other in the y direction.

In the input device A2, portions of the wiring 31 formed in the non-detection region r2 (e.g. the line elements 311) may be made of a transparent conductive material such as ITO or IZO, or a metal such as Al, Ag or Au.

The technical advantages of the input device A2 will be described below.

The line elements 312, 313 extend from the electrode elements 11 toward the boundary line r3, while the line elements 314, 315 extend from the electrode elements 11 toward the boundary line r4. In this manner, the number of the line elements crossing the boundary line r3 can be reduced. Further, the line elements 313 and the line elements 314 are configured to pass through mutually different series of gaps s1. Thus, it is possible to reduce the number of line elements formed in a gap s1, thereby reducing the size of the gap s1. When the portions of the wiring 31 in the non-detection region r2 are made of a metal, the resistance of the wiring 31 can be reduced.

It may be readily understood that, in addition to the foregoing, the input device A2 can enjoy other technical advantages same as those of the input device A1 with respect to the arrangements identical or similar to those of the above first embodiment.

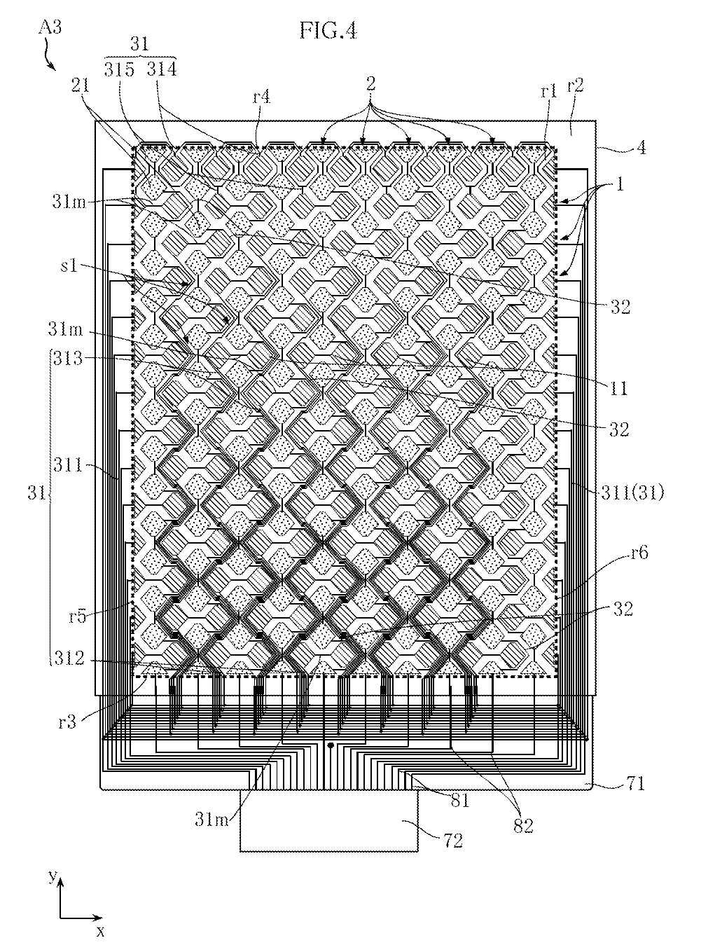

FIG. 4 illustrates an input device A3 according to a third embodiment of the present invention. The input device A3 may differ from the input device A2 in that paired electrode elements 11 adjacent in the x direction are connected to each other by a portion of wiring 31 (line element 31m) formed in a region between the adjacent electrode elements 11.

One of the paired electrode elements 11 connected by the line element 31m is also connected to one of the line elements 311, 312, 313 and 315, while the other electrode element 11 is connected to the line element 31m only (thus, called “single connection electrode element” below). For each line element 31m, two electrode elements 21 are arranged to flank the line element 31m in the y direction. The portion of the wiring 32 for connecting the two electrode elements 21 is arranged to extend around one of the two electrode elements 11 connected by the line element 31m (that is, around the single connection electrode element 11).

The technical advantages of the input device A3 will be described below.

In the input device A3, use is made of a number of line elements 31m each for connecting two electrode elements 11 to each other. Thus, each of the line elements (wiring 31) extending from the detection region r1 onto the non-detection region r2 is connected only to one of the two electrode elements 11. Accordingly, the number of line elements drawn onto the non-detection region r2 can be reduced, and the respective gaps r1 can be small. As a result, the overall area the first and second electrodes 1, 2 occupy in the detection region r1 can be increased, thereby improving the detection sensitivity of the input device A3. In addition, it is possible to reduce the number of line elements of the auxiliary wiring 81 formed on the flexible board 71, thereby enabling the downsizing of the flexible board 71. The reduction of the line elements of the auxiliary wiring 81 can reduce the number of crossing points between the auxiliary wirings 81 and 82. Accordingly, the parasitic capacitance produced between the wirings 81 and 82 can be reduced, which also contributes to improving the detection sensitivity of the input device A3.

Each line element 31m connects two electrode elements 11 only. Thus, the total length of the wiring 32 is not unduly long, even when the wiring 32 is disposed so as to surround these electrode elements 11. As a result, the resistance of the wiring 32 can be substantially the same as that in the input device A2.

The line elements 311, 312, 313, 315 for electrical connection to the paired electrode elements 11 connected by the line element 31m may not need to be directly connected to one of the electrode elements 11, but may be directly connected to the line element 31m.

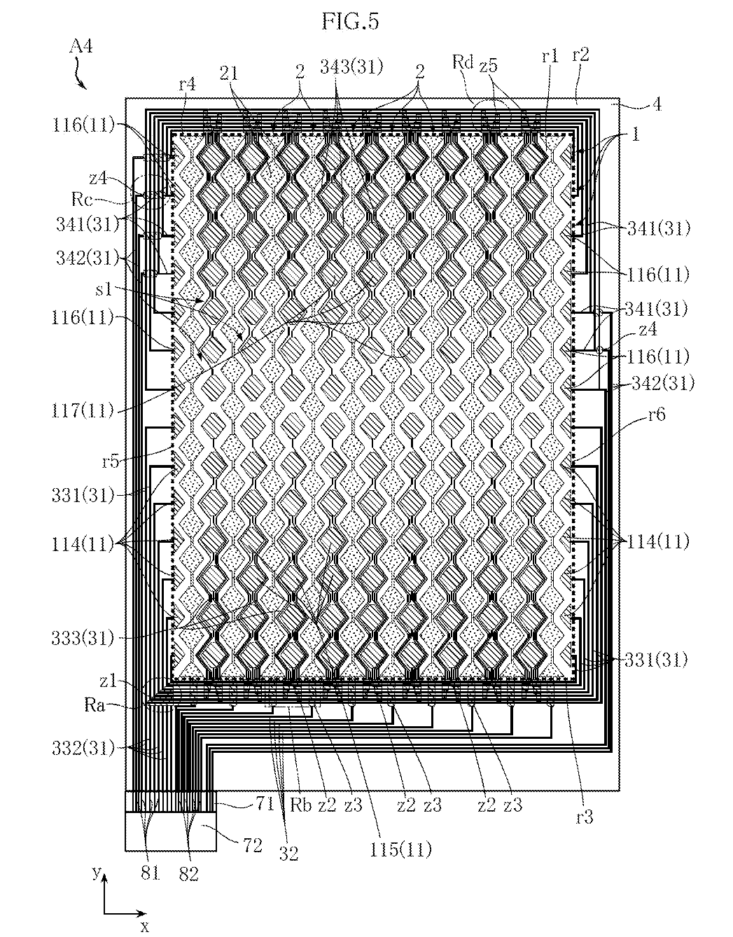

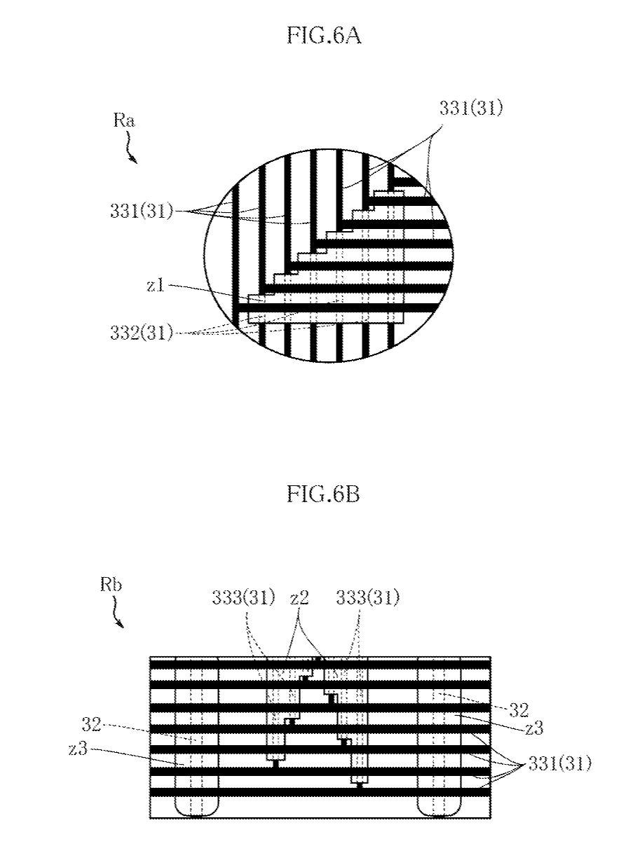

FIGS. 5, 6A and 6B illustrate an input device A4 according to a fourth embodiment of the present invention. The input device A4 differs from the input device A2 in the following respects.

In the input device A4, the arrangement of line elements (wiring 31) is different between the line elements connected to the electrode elements 11 (triangular electrode elements 114 and rhombic electrode elements 115) disposed in the lower half of the detection region r1 and the line elements connected to the electrode elements 11 (triangular electrode elements 116 and rhombic electrode elements 117) disposed in the upper half of the detection region r1. Specifically, the line elements connected to connected to electrode elements 114, 115 are arranged to extend downward in FIG. 5 (toward the boundary line r3), while the line elements connected to connected to electrode elements 116, 117 are arranged to extend upward (toward the boundary line r4). In addition, the line elements (wiring 31) extending in the non-detection region r2 are mutually connected in the non-detection region r2, not on the flexible board 71.

The wiring 31 includes line elements 331, 332, 333, 341, 342, 343. These line elements may be made of a transparent conductive material such as ITO or IZO, or a metal such as Al, Ag or Au.

The line elements 331 are connected to the triangular electrode elements 114. Specifically, as shown in FIG. 5, the line elements 331 connected to the right-hand triangular electrode elements 114 extend downward in the non-detection region r2 along the boundary line r6, and then bend to the left to extend along the boundary line r3. Further, the line elements 331 bend upward at the lower left region Ra, and extend upward along the boundary line r5, finally to be connected to the left-side triangular electrode elements 114.

The line elements 332 are connected to the line elements 331 in the region Ra. The line elements 332 extend downward from the region Ra to be connected to the auxiliary wiring 81 formed on the flexible board 71.

Each of the line elements 333 is connected to a corresponding one of the electrode elements 115 in the lower half of the detection region r1. The line elements 333 extend downward in the y direction from the electrode elements 115. The line elements 333 are connected to the line elements 331 in the non-detection region r2 (for instance at the region Rb adjacent to the boundary line r3). As a result, the electrode elements 11 of the respective first electrodes 1 disposed in the lower half of the detection region r1 are properly connected.

As illustrated in FIG. 6A, the line elements 331 and the line elements 332 overlap with each other at the region Ra. An insulating layer z1 is provided in the region Ra between the mutually overlapping line elements 331 and 332 so that any one of the line elements 331 and any one of the line elements 332 are electrically separated if these two line elements are connected to different first electrodes 1.

As shown in FIG. 6B, the line elements 331 and the line elements 333 overlap with each other at the region Rb. Insulating layers z2 are provided in the region Ra between the mutually overlapping line elements 331 and 333 so that any one of the line elements 331 and any one of the line elements 333 are electrically separated if these two line elements are connected to different first electrodes 1. Further, in the region Rb, the line elements 331 and the wiring 32 overlap with each other. Insulating layers z3 are provided in the region Rb between the mutually overlapping line elements 331 and the wiring 32. Similar insulating layers may be provided at a region other than the region Rb, where a line element 331 overlaps with a line element 333 or with the wiring 32, and the overlapping elements or wiring are connected to different first electrodes 1.

As illustrated in FIG. 5, the line elements 341 are connected to the triangular electrode elements 116. Specifically, the line elements 341 connected to the right-hand triangular electrode elements 116 extend upward along the boundary line r6 in the non-detection region r2. Then, the line elements 341 bend to the left to extend along the boundary line r3 in the non-detection region r2, and bend again downward at the upper left corner. Thereafter, the line elements 341 extend downward along the boundary line r5, and bend to the right (see the region Rc), to be connected to the left-side triangular electrode elements 116.

The line elements 342 are connected to the line elements 341 at portions where the respective line elements 341 are bent to the right. The line elements 342 extend along the boundary line r5 onto the flexible board 71. The line elements 342 are connected to the auxiliary wiring 81 formed on the flexible board 71.

Each of the line elements 343 is connected to a corresponding one of the electrode elements 117. The line elements 343 extend upward from the electrode elements 117 to the boundary line r4 and are connected to the line elements 341 in the non-detection region r2 (see the region Rd). As a result, the electrode elements 11 of any one of the first electrodes 1 disposed in the upper half of the detection region r1 are properly connected.

In the region Rc, like the regions Ra, Rb, the line elements 341 and 342 connected to different first electrodes 1 overlap with each other. In the region Rc, an insulating layer z4 is provided between the stacked line elements 431 and 342 connected to different first electrodes 1. Also, in the region Rd, the line elements 341 and 343 connected to different first electrodes 1 overlap with each other. In the region Rd, an insulating layer z5 is provided between the stacked line elements 431 and 343 connected to different first electrodes 1. Similar insulating layers may be provided at a region other than the regions Rc, Rd, where a line element 341 overlaps with a line element 342 or with a line element 343, and the overlapping elements are connected to different first electrodes 1.

In the input device A4, the line elements 333, 343 formed in the detection region r1, the first electrodes 1 and the second electrodes 2 may preferably be made of the same transparent conductive material, so that the detection region r1 provides a fine appearance (that is, no silhouettes of the line elements and electrodes are visible in the detection region r1). Also, using the same material enables collective production of the first electrodes 1, the second electrodes 2, and the line elements 333, 343. In addition, by using the same transparent material to produce the line elements 331, 332, 341, 342 in the non-detection region r2, the manufacturing process can be further simplified.

The line elements 331, 332, 341, 342 may be made of a metal such as Al, Ag or Au. In this case, the resistance of the line elements 331, 332, 341, 342 can be reduced. Since the line elements 331, 332, 341, 342 are provided in the non-detection region r2, the above-mentioned appearance of the detection region r1 does not deteriorate.

As explained above, the wiring 31 and the wiring 32 are arranged to overlap with each other at the regions Ra, Rb, Rc, Rd. Of the two wirings 31 and 32, the one closer to the transmitting plate 4 (i.e., The lower one) may be made of a transparent conductive material, while the one farther from the transmitting plate 4 (i.e., the upper one) may be made of a metal. With this arrangement, the lower one of the wirings 31 and 32 can be formed simultaneously with the first electrodes 1 and the second electrodes 2, and also the resistance of the upper one of the two wirings 31 and 32 can be reduced. Alternatively, the lower one of the two wirings 31 and 32 may be made of a metal.

The line elements 333 are connected to the electrode elements 115 disposed in the lower half of the detection region r1, and extend downward, while the line elements 343 are connected to the electrode elements 117 disposed in the upper half of the detection region r1, and extend upward. In other words, a portion of the wiring 31 (line element 333 or 343) connected to an electrode element 11 is arranged to extend toward one of the boundary lines r3, r4 which is closer to the electrode element 11. In this manner, it is possible to reduce the total length of the wiring 31 in the detection region r1, and hence the resistance of the wiring 31. Accordingly, the detection sensitivity of the input device A4 can be enhanced, and the detection accuracy relevant to the first electrodes 1 or second electrodes 2 can be prevented from varying by location.

The insulating layers z1 to z5 at regions Ra, Rb, Rc, Rd are disposed in the non-detection region r2. Hence, the optical transmittance and refractive index of the detection region r1 is not affected by the insulating layers z1 to z5. Also, precision processing may not be necessary for insulating layers z1 to z5 to be formed in the non-detection region r2. Thus, the manufacturing process of the input device A4 can be simplified.

The connection between the line elements 331, 332, 333 is made in the non-detection region r2 on the transmitting plate 4, and so is the connection between the line elements 341, 342, 343. In this manner, the number of the line elements of the auxiliary wire 81 to be formed on the flexible board 71 can be reduced, which contributes to the downsizing of the flexible board 71.

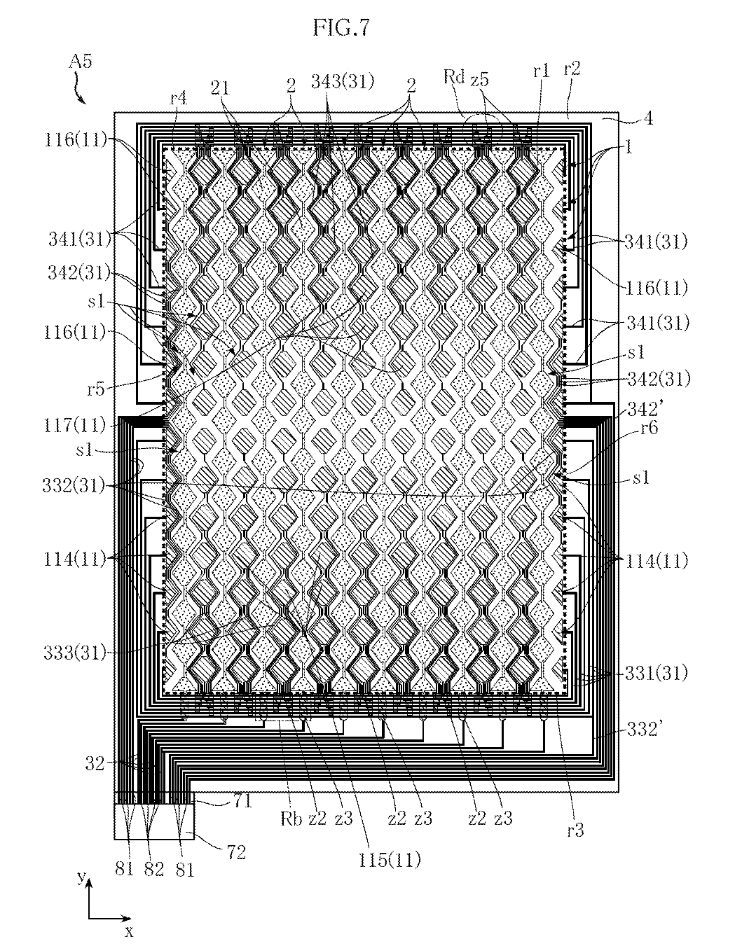

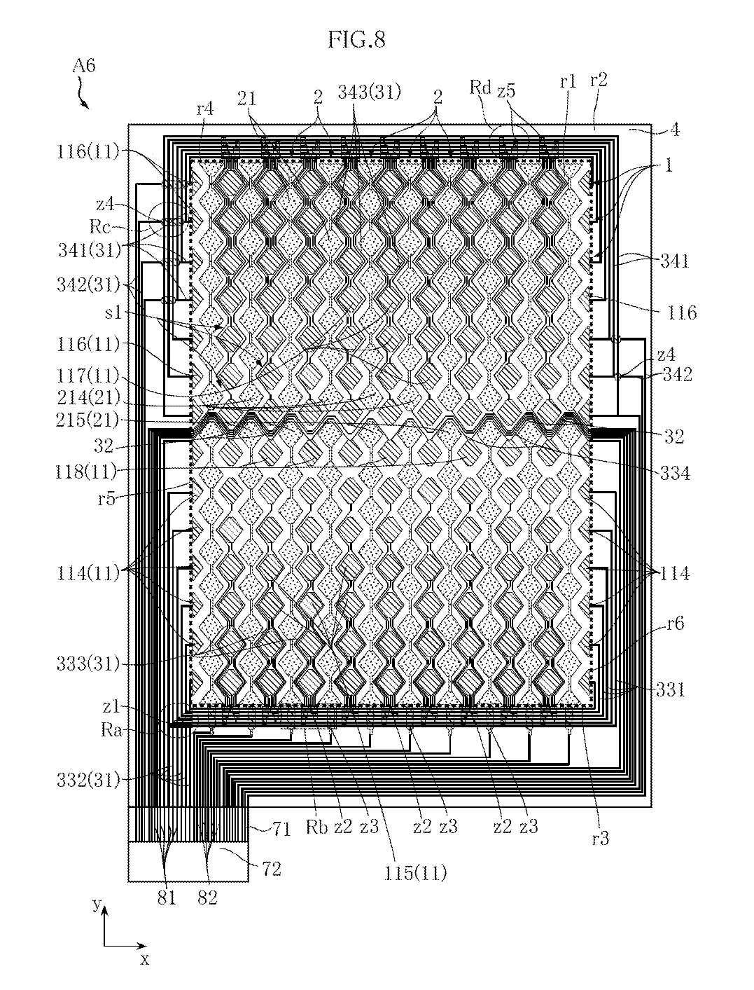

FIG. 7 illustrates an input device A5 according to a fifth embodiment of the present invention.

In the input device A5, the line elements 332 (except the line elements 332′) are not directly connected to the line elements 331, but to the electrode elements 114, while also being arranged in the gaps s1 between the electrode elements 114 and the electrode elements 21 adjacent to the electrode elements 114. Likewise, the line elements 342 (except the line elements 342′) are not directly connected to the line elements 341, but to the electrode elements 116, while also being arranged in the gaps s1 between the electrode elements 116 and the electrode elements 21 adjacent to the electrode elements 116.

The line elements 332 in the detection region r1 extend upward from the electrode elements 114 along the boundary line r5 or r6, and then the line elements 332 cross the boundary line r5 or r6 at its central portion in the y direction. The line elements 332 in the non-detection region r2 extend downward along the boundary line r5 or r6, and further onto the flexible board 71.

The line element 332′ is connected to the line elements 331 in a lower right area of the non-detection region r2. The wiring 332′ also extends onto the flexible board 71.

The line elements 342 in the detection region r1 extend downward along the boundary line r5 or r6 from the electrode elements 116. Then, the line elements 342 cross the boundary line r5 or boundary line r6 at its central portion in the y direction. The line elements 342 in the non-detection region r2 extend downward along the boundary line r5 or r6, and further onto the flexible board 71.

The line element 342′ is connected to the line elements 341 at a central portion of the non-detection region r2 in the y direction. The wiring 342′ also extends onto the flexible board 71.

In the input device A5, the line elements 331 and the line elements 332 are not stacked on each other. Thus, there are no such intersections of the line elements 331 and the line elements 332 as those shown in region Ra of FIG. 5. This arrangement can reduce the parasitic capacitance between the line elements 331 and the line elements 332, thereby enhancing the detection sensitivity of the input device A5. Likewise, in the input device A5, the line elements 341 and the line elements 342 are not stacked on each other. Thus, there are no such intersections of the line elements 341 and the line elements 342 as those shown in region Rc of FIG. 5. This arrangement can reduce the parasitic capacitance between the line elements 341 and the line elements 342, thereby enhancing the detection sensitivity of the input device A5

FIG. 8 illustrates an input device A6 according to a sixth embodiment of the present invention.

In the input device A6, line elements 334 are provided for connecting the electrode elements 118, which are ones of the electrode elements 11 that are disposed at the center in the y direction. These line elements 334 are arranged in the gaps between the electrode elements 214 and 215 adjacent in the y direction. Also, in the input device A6, wiring 32 connected to the electrode elements 214 extends along the line elements 334 toward the boundary line r5 or r6. In the non-detection region r2, the wiring 32 extends downward along the boundary line r5 or r6, and is connected to the auxiliary wiring 82 formed on the flexible board 71.

In the input device A6, the electrode elements 118 are electrically connected to one another by the line elements 334. Thus, there is no need to form line elements 331 for electrically connecting the electrode elements 118. This arrangement can reduce the number of intersections between the wirings 31 and 32 in region Ra or region Rb, for example. Accordingly, the parasitic capacitance on the wiring 31 or the parasitic capacitance between the wirings 31 and 32 can be reduced, thereby enhancing the detection sensitivity of the input device A6.

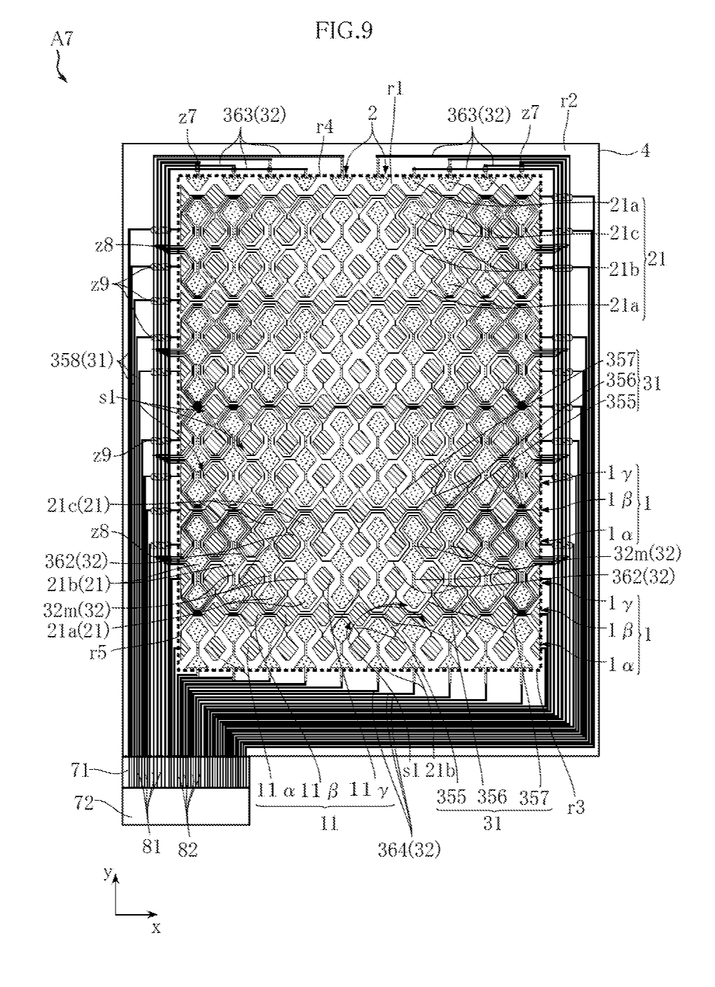

FIG. 9 illustrates an input device A7 according to a seventh embodiment of the present invention.

The input device A7 may differ from the input device A4 in arrangement of the wirings 31 and 32. As shown in FIG. 9, the respective electrodes 1 are assigned, from below, reference numerals 1α, 1β, 1γ, 1α, 1β, 1γ, and so forth. The electrode elements 11 included in the electrodes 1α, 1β, 1γ are denoted as electrode elements 11α, 11β, 11γ, respectively.

The wiring 31 includes line elements 355, 356, 357 and 358. The line elements 355 electrically connect the electrode elements 11α to one another. The line elements 355 extend through gaps 31 located at the upper right and upper left of the respective electrode elements 11α. In addition, the line elements 355 extend through the gaps between adjacent electrode elements 11β.

The line elements 356 electrically connect the electrode elements 11β to one another. The line elements 356 are formed in gaps between adjacent electrode elements 11β, while also, extending in the x direction.

The line elements 357 electrically connect the electrode elements 11γ to one another. The line elements 357 extend through gaps s1 located at the lower right and lower left of the respective electrode element 11γ. In addition, the line elements 357 extend through the gaps between adjacent electrode elements 11β.

The line elements 358 are connected to the electrode elements 11α, 11β, 11γ disposed at one end in the x direction. The line elements 358 extend from the electrode elements 11α, 11β, 11γ toward the boundary line r5 or r6, and then extend downward in the non-detection region r2. The line elements 358 are connected to the wiring 81 formed on the flexible board 71.

The wiring 32 includes line elements 32m, 362, 363 and 364. The line elements 32m link to one another electrode elements 21 that are mutually adjacent in the y direction,

The line elements 32m connect electrode elements 21a, 21b and 21b, 21c which are mutually adjacent in the y direction. Thus, the electrode elements 21a, 21b and 21c are electrically connected to one another.

The line elements 362 are connected to the electrode elements 21b. The line elements 362 extend from the electrode elements 21b toward the boundary line r5 or r6. Specifically, each of the line elements 362, connected to a corresponding one of the electrode elements 21b, extends toward one of the boundary lines r5 and r6 which is closer to the above-mentioned corresponding one of the electrode elements 21b.

Each line element 362 is disposed so as not to overlap any of the electrode elements 21 (other than the electrode element 21 connected to the particular line element 362), the electrode elements 11, and the wirings 31, 32, in a manner such that the line element is arranged to skirt around the electrode element 21a or 21c which is at one end of the electrode elements 21a, 21b, 21c.

The line elements 363 are connected to the electrode elements 21a disposed at the top in the figure. The line elements 363 extend, in the non-detection region r2, from the electrode elements 21a leftward or rightward, along the boundary line r4, and further extend downward along the boundary line r5 or r6. Then, the line elements 363 are connected to the auxiliary wiring 82 formed on the flexible board 71. The line elements 363 are connected to one end of the line elements 362 at portions where the line elements 363 extend downward along the boundary line r5 or r6.

Above the boundary line r4, the line elements 363 intersect other line elements 363 connected to different electrode elements 21. At these intersections, the line elements 363 are stacked with insulating layers z7 interposed between them. This arrangement prevents the line elements 363 connected to different electrodes 2 from being electrically connected to each other. Likewise, the line elements 363 intersect the line elements 362 at portions where the line elements 363 extend downward along the boundary line r5 or r6. At these intersections, the line elements 363 and the line elements 362 are stacked with insulating layers z8 interposed between them. This arrangement prevents the line elements 363 and line elements 362 connected to different electrodes 2 from being electrically connected to each other. Also, the line elements 363 intersect the line elements 358 at portions where the line elements 363 extend downward along the boundary line r5 or r6. At these intersections, the line elements 363 and the line elements 358 are stacked with insulating layers z9 interposed between them. This arrangement prevents the line elements 363 and the line elements 358 from being electrically connected to each other.

The line elements 364 are connected to the electrode elements 21b disposed at the bottom. The line elements 364 are also connected to the auxiliary wiring 82.

In the input device A7, the line elements 32m electrically connect the electrode elements 21a, 21b, 21c to one another. Thus, electrode elements 21 included in the same second electrode 2 can be electrically connected to one another simply by connecting the wiring 32 extending onto the non-detection region r2 to the electrode elements 21b. That is, there is no need to connect the wiring 32 extending onto the non-detection region r2 to the electrode elements 21a, 21c. This reduces the number of line elements of the wiring 32 extending onto the non-detection region r2, and hence the number of intersections between the wirings 31 and 32 in the non-detection region r2. Accordingly, the parasitic capacitance between the wirings 31 and 32 can be reduced. Further, since the number of line elements of the wiring 32 extending onto the non-detection region r2 can be reduced, the flexible board 71 can be made smaller in size.

In FIG. 9, the line elements 362 connected to the electrode elements 21b disposed in the left half of the detection region r1 extend leftward, while the line elements 362 connected to the electrode elements 21b disposed in the right half of the detection region r1 extend rightward. In other words, the line elements 362 extend toward one of the boundary lines r5 and r6 that is closer to the electrode elements 21b to which the line elements 362 are connected. This arrangement shortens the length of the line elements 362 in the detection region r1, thereby reducing the resistance of the line elements 362. Accordingly, the detection sensitivity of the input device A7 can be enhanced, and the variation in detection accuracy of the electrodes 1, 2 can be reduced.

One of the line elements 362 connected to electrode elements 21b adjacent in the x direction is arranged to skirt around an electrode element 21a, while the other of the line elements 362 is arranged to skirt around an electrode element 21c. These line elements 362 do not extend through the same gaps Si, and hence the width of the gaps s1 can be smaller. On the other hand, the total area the electrodes 1, 2 occupy in the detection region r1 can be greater, and hence the detection sensitivity of the input device A7 can be enhanced.

The length of the boundary lines r3, r4 extending in the x direction is smaller than the length of the boundary lines r5, r6 extending in the y direction. Thus, forming line elements 362 extending in the x direction can shorten the length the line elements 362.

As noted above, electrical conduction is made between a line element 362 and electrode elements 21 connected by a line element 32m. To this end, the line element 362 may not be directly connected to one of the electrode elements 21. For instance, the line element 362 may be directly connected to the line element 32m.

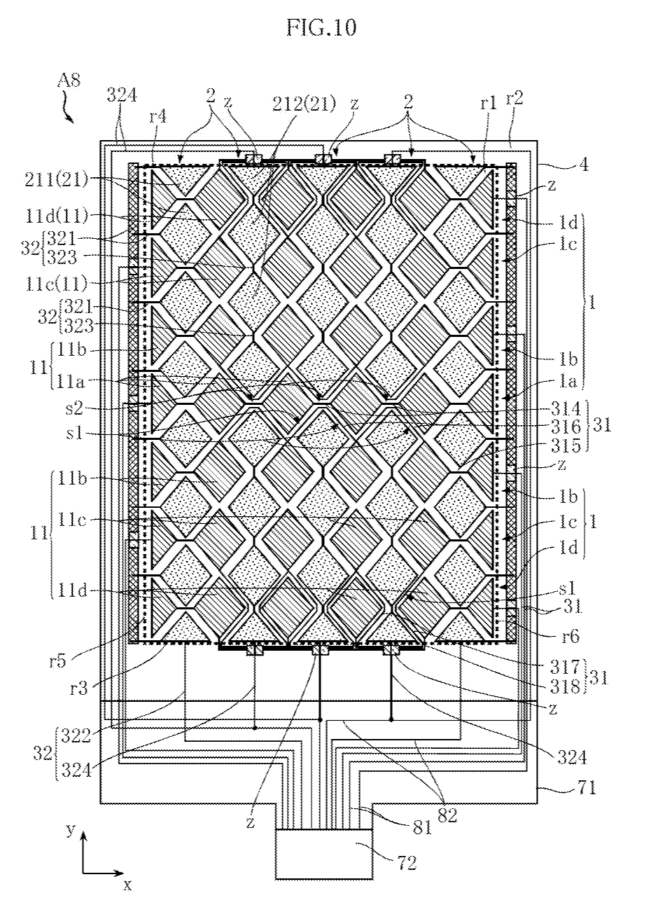

FIG. 10 illustrates an input device A8 according to an eighth embodiment of the present invention.

The electrodes 1 include an electrode 1a which is central in the y direction, and also electrodes 1b, 1c and 1d which are increasingly farther from the center. The electrodes 1a, 1b, 1c and 1d are made up of electrode elements 11a, 11b, 11c and 11d, respectively. The electrode 1a, for instance, traverses the detection region r1, extending in the direction.

The electrode elements 21 include electrode elements 211 that are disposed at both ends in the x direction. Among the electrode elements 21, the elements other than the electrode elements 211 are indicated by reference numeral 212.

Gaps s2 are formed between adjacent electrode elements 212 at a central portion in the y direction in FIG. 10. The gaps s2 are also flanked by adjacent electrode elements 11a. A plurality (e.g. three) of gaps s2 are arranged in the x direction.

The wiring 32 is formed on the front surface 4a of the transmitting plate 4. The wiring 32 includes line elements 321 or 322 connected to the electrode elements 211. The wiring 32 also includes line elements 323 or 324 connected to the electrode elements 212.

The line elements 321 extend from the electrode elements 211 in the x direction toward the boundary line r5 or r6. The line elements 321 are connected to one another in the non-detection region r2. The portions of the line elements 321 formed in the non-detection region r2 are made of a metal such as Ag or Al. In FIG. 10, the metal portions are indicated by hatching. The line elements 322 extend downward from the electrode elements 211 disposed at the bottom. The line elements 323 are formed in gaps flanked by the electrode elements'212, and connect these electrode elements 212 to one another. However, no line elements 323 are formed in the gaps s2. The line elements 324 extend upward from the uppermost electrode elements 212, and extend downward from the lowermost electrode elements 212. The line elements 324 intersect the line elements 317, 318 in the non-detection region r2 adjacent to the boundary lines r3, r4. An insulating layer z is formed so as to prevent conduction between the line elements 324 and the line elements 317, 318.

The wiring 31 is formed on the front surface 4a of the transmitting plate 4. The wiring 31 comprises the line elements 314, 315, 316, 317 and 318. The line elements 314 are formed in the gaps s2. The line elements 314 electrically connect the electrode elements 11a to one another. The line elements 315 are connected to ones of the electrode elements 11b, 11c, 11d, which are adjacent to the boundary lines r5, r6, and the line elements 315 extend inward of the detection region r1. The line elements 316 electrically connect the electrode elements 11b to one another. The line elements 316 extend from the electrode elements 11b in the detection region r1, and further through the gaps s1, s2 adjacent to the electrode elements 11a. The line elements 317 electrically connect the electrode elements 11c to one another. The line elements 317 extend from the electrode elements 11c toward the boundary line r3 or r4, passing through the gaps s1 adjacent to the electrode elements 11d. The line elements 318 electrically connect the electrode elements 11d to one another. The line elements 318 extend from the electrode elements 11d toward the boundary line r3.

The auxiliary wiring 82 is connected to corresponding ones of the line elements 322, 324. Parts of the wiring 82 connected to the line elements 324 are connected to one another on the flexible board 71. Thus, the upper and lower electrode elements 212 flanking the gaps s2 are connected to one another.

The auxiliary wiring 81 is connected to parts of the wiring 31 that extend from the electrode elements 11 disposed at the end in the x direction.

In the input device A8, the electrode elements 11b can be connected to one another by the line elements 316 formed in the gaps 31, s2. Thus, no wiring 31 need be formed in the non-detection region r2 for connection of the electrode elements 11b. This is advantageous to the shortening of the line elements 316, and hence to the reducing of the resistance of the wiring 31. Moreover, it is possible to reduce the number of intersections between the wiring 31 and the wiring 32 in the non-detection region r2. Accordingly, the number of insulating layers provided to insulate the wirings 31 and 32 in the non-detection region r2 can also be reduced.

The line elements 321 have portions extending in the x direction to the boundary line r5 or r6. This makes it possible to provide portions of the wiring 31 at the gaps between adjacent electrode elements 211, thereby connecting electrode elements 11 adjacent to the gaps. This is advantageous to the shortening of the wiring 31, and hence to the reducing of the resistance of the wiring 31.

The line elements 318 extend from the electrode elements 11d toward the non-detection region r2, but not inward of the detection region r1. Accordingly, the line elements 318 need not be formed in the gaps s2. This reduces the number of the wiring 31 (line elements) formed in the gaps s2, which is advantageous to reducing the size of the gaps s2. On the other hand, the surface area to be occupied by the electrodes 1, 2 in the detection region r1 can be increased, which is advantageous to enhancing the sensitivity of the input device A8.

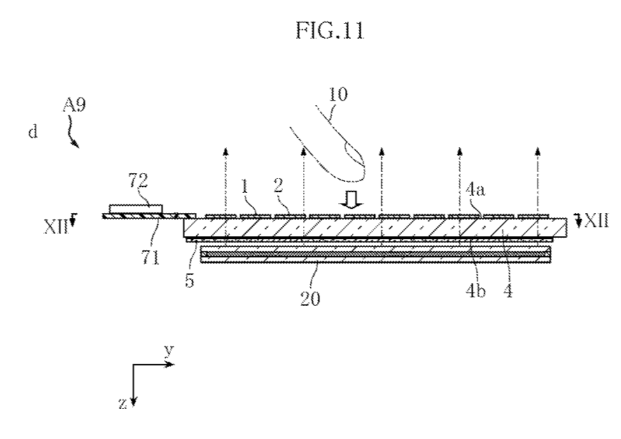

FIGS. 11-13 show an input device A9 according to a ninth embodiment of the present invention. Likewise of the above-described input devices, the input device A9 is configured to detect the approach of a finger 10 based on the change of capacitance, and comprises first electrodes 1, second electrodes 2, wiring 31, wiring 32, a transmitting plate 4, a shield layer 5, a flexible board 71 and an IC chip 72. In addition, the input device A9 comprises an insulating layer 6 (to be described later).

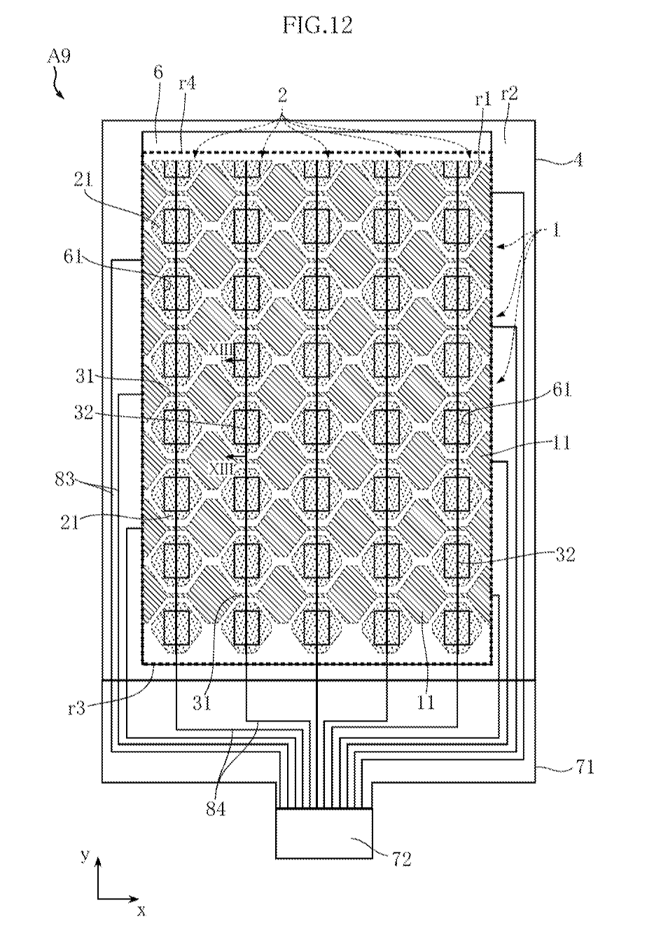

As shown in FIG. 12, a rectangular detection region r1 is provided on the transmitting plate 4, and around the detection region r1 is a frame-like non-detection region r2. In the illustrated example, two boundary lines corresponding to the short sides of the rectangle are indicated by reference signs (r3, r4).

As shown in FIG. 12, each of the first electrodes 1 comprises a plurality of electrode elements 11 arranged in a row extending in the x direction. Each of the second electrodes 2 comprises a plurality of electrode elements 21 arranged in a row extending in the y direction.

The wiring 31 comprises conductive “connection elements” formed in areas each flanked by two electrode elements 11 adjacent in the x direction. In the illustrated example, five connection elements are provided for each first electrode 1.

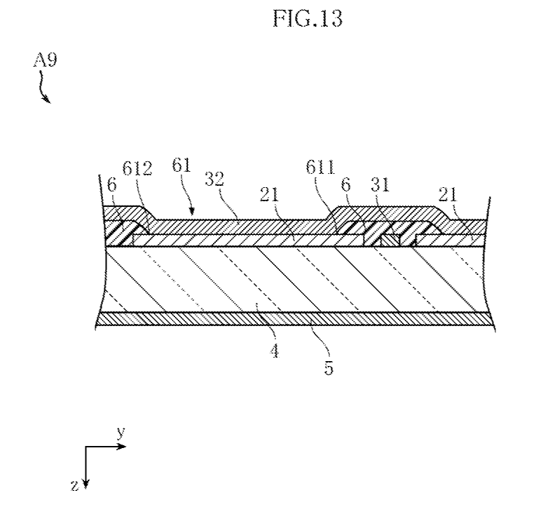

The insulating layer 6 is stacked on the first electrodes 1, the second electrodes 2, and the wiring 31. The insulating layer 6 may be made of SiO₂, for example. As shown in FIGS. 12 and 13, the insulating layer 6 is formed with a plurality of rectangular openings 61. Each of the openings 61 is located at a position overlapping a corresponding one of the electrode elements 21, and arranged to expose part of the surface of the corresponding electrode element 21. The insulating layer 6 entirely covers the detection region r1 except at the portions where the openings 61 are formed. In other words, the insulating layer 6 covers the electrode elements 11, and also the wiring 31 (the connection elements) formed in the detection region r1.

As shown in FIG. 12, the wiring 32 comprises a plurality of mutually parallel line elements each connecting electrode elements 21 of a relevant one of the second electrodes 2. Each line element corresponds to a corresponding one of the second electrodes 2 and extends in the y direction, from near the boundary line r4 to the boundary line r3. According to the present invention, two or more line elements may be provided for each second electrode 2. Such line elements (wiring 32) may be made of a metal such as Ag or Al, or of a transparent organic conductive material.

As shown in FIG. 13, each line element (wiring 32) is formed on the insulating layer 6 and the upper surface of the electrode elements 21 exposed through the openings 61 so as to be electrically connected to the electrode elements 21. The directly connecting portion of the line element (wiring 32) with respect to the electrode element 21 extends in the y direction, from one end 611 to the opposite end 612 of the opening 61.

Peripheral wiring 83 is connected to the electrode elements 11 disposed at both ends in the x direction. The peripheral wiring 83 is formed in the non-detection region r2 and on the flexible board 71. In the non-detection region r2, the peripheral wiring 83 extends in the y direction. The peripheral wiring 83 is made of a metal such as Ag or Al, for example. Alternatively, the peripheral wiring 83 may comprise metal lines (made of e.g. Ag or Al) formed on a thin film of ITO or IZO.

Peripheral wiring 84 is connected to the electrode elements 21 disposed at one end in the y direction. The peripheral wiring 84 is formed in the non-detection region r2 and on the flexible board 71. The peripheral wiring 84 is made of a metal such as Ag or Cu, for example.

The first electrodes 1, the second electrodes 2, the wiring 31, the wiring 32 and the peripheral wiring 83, the peripheral wiring 84 are partially covered by a coating layer (not shown). The coating layer suppresses the deterioration of visibility due to reflection of external light and also protects the electrodes 1, 2 and the wirings 31, 32 from damage.

The IC chip 72 is connected to the first electrodes 1 and the second electrodes 2 by the peripheral wirings 83, 84. The IC chip 72 is configured to constantly and individually check two kinds of capacitance change, i.e., the change in capacitance between the finger 10 and the first electrodes 1, and the change in capacitance between the finger 10 and the second electrodes 2. The IC chip 72 may be mounted on the transmitting plate 4.

In the input device A9, the connecting portions of the wiring 32 with respect to the electrode elements 21 can be great in size (long). Accordingly, the wiring 32 and the electrode elements 21 are firmly attached, so as not to be readily detached.

Each of the connecting portions is formed to extend from one end 611 to the opposite end 612 of the opening 61. This arrangement is suitable for increasing the size of the connecting portion in the y direction.

The insulating layer 6 entirely covers the first electrodes 1 and the wiring 31. This prevents the wiring 32 from coming into contact with the first electrodes 1 or the wiring 31.

The wiring 32 and the peripheral wirings 83, 84 extend generally in the y direction. These wirings may be made of the same material. For instance, Ag paste may be applied by screen printing, and then patterned into a desired configuration of wiring. In such a case, if two or more wiring patterns coexist, one of which may extend in the x direction and another in the y direction, it is required to perform high-accuracy positioning in the screen printing method. However, in the example shown in FIG. 12, where the wirings extend only in the y direction, it suffices to perform less accurate positioning with respect to the y direction. Thus, the wiring arrangement in the input device A9 is suitable for simplifying the manufacturing process.

The wiring 32 and the peripheral wirings 83, 84 are made of a metal. Thus, it is possible to reduce the resistance of the wring 32 and the peripheral wirings 83, 84.

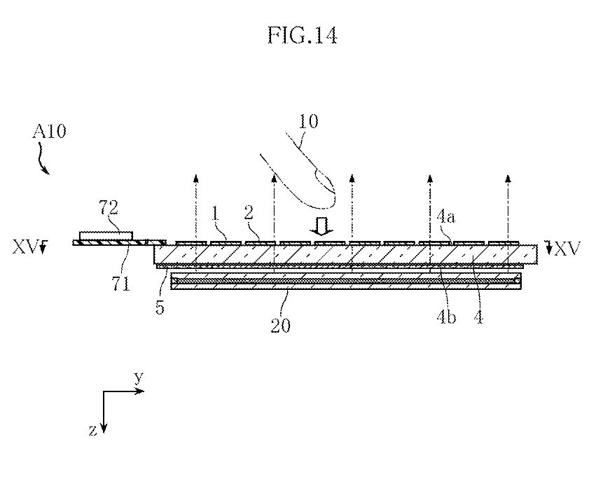

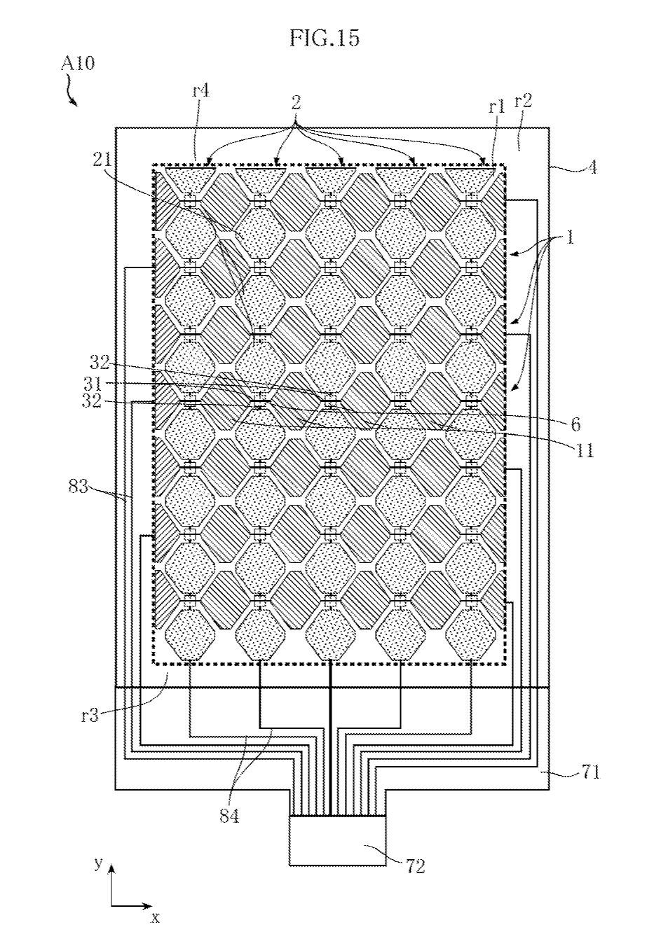

FIGS. 14 and 15 show an input device A10 according to a tenth embodiment of the present invention. The input device A10 comprises first electrodes 1, second electrodes 2, wiring 31, wiring 32, a transmitting plate 4, a shield layer 5, an insulating layer 6, a flexible board 71 and an IC chip 72. As shown in FIG. 15, each of the first electrodes 1 includes a plurality of electrode elements 11 arranged in the direction, and each of the second electrodes 2 includes a plurality of electrode elements 21 arranged in the y direction.

The wiring 32 is arranged to connect electrode elements 21 belonging to the same second electrode 2. The wiring 32 comprises a plurality of connection elements made of a metal such as Ag, Al or Au, for example. The wiring 32 may be formed by a screen-printing method, for example, after the first electrodes 1 and the second electrodes 2 are formed on the transmitting plate 4.

The insulating layer 6 is formed on the wiring 32. The insulating layer 6 may be made of SiO₂, for example.

The wiring 31 is formed on the insulating layer 6. The wiring 31 is arranged to connect electrode elements 11 belonging to the same first electrode 1. The wiring 31 is formed in regions flanked by two electrode elements 11 adjacent in the x direction, and comprises conductive connection elements connecting the adjacent electrode elements 11. The wiring 31 may be made of a metal such as Ag, Al or Au, for example.

Peripheral wiring 83 is connected to the electrode elements 11 disposed at both ends in the x direction. The peripheral wiring 83 is formed in the non-detection region r2 and on the flexible board 71. In the non-detection region r2, the peripheral wiring 83 extends in the y direction. The peripheral wiring 83 may be made of a metal such as Ag or Al, for example. Alternatively, the peripheral wiring 83 may comprise metal lines of e.g. Ag or Al, formed on a thin film of ITO or IZO.

Peripheral wiring 84 is connected to the electrode elements 21 disposed at one end in the y direction and arranged in the x direction. The peripheral wiring 84 is formed in the non-detection region r2 and on the flexible board 71. The peripheral wiring 84 may be made of a metal such as Ag or Cu, for example.

The first electrodes 1, the second electrodes 2, the wiring 31, the wiring 32 and the peripheral wirings 83, 84 are partially covered by a coating layer (not shown). The coating layer suppresses the deterioration of visibility due to reflection of external light and also protects the electrodes 1, 2 and the wirings 31, 32 from damage.

The IC chip 72 is connected to the first electrodes 1 and the second electrodes 2 by the peripheral wirings 83, 84. The IC chip 72 is configured to constantly and individually check two kinds of capacitance change, i.e., the change in capacitance between the finger 10 and the first electrodes 1, and the change in capacitance between the finger 10 and the second electrodes 2. The IC chip 72 may be mounted on the transmitting plate 4.

In the input device A10, the wirings 31, 32 are made of a metal. Thus, the wirings 31, 32 have an advantageously low resistance. Further, the total resistance of the mutually connected members including the connection elements (wiring 31), the electrode elements 11 and the peripheral wiring 83 can be equal or generally equal to the total resistance of the mutually connected members including the connection elements of wiring 32, the electrode elements 21 and the peripheral wiring 84. Accordingly, variation in the detection sensitivity of the input device A10 can be reduced. On the other hand, when the resistances of the wirings 31, 32 are to be kept constant, it is possible to reduce the width of the wirings 31, 32. Accordingly, the overlapping areas of the wirings 31, 32 can be small, thereby reducing the parasitic capacitance in the wirings 31, 32. As a result, the detection sensitivity of the input device A10 can be enhanced. Further, since the width of the wirings 31, 32 can be small, the image visibility in the detection region r1 does not significantly deteriorate even when the wirings 31, 32 are made of metal.

The scope of the present invention is not limited to the above-described embodiments. The specific configuration of the elements of the input device according to the present invention can be varied in many ways. For instance, it is possible that the input device according to the present invention is not used with a liquid crystal panel. In this case, the first electrodes and the second electrodes may not be transparent, and may be made of a non-transparent metal such as copper. Further, the input device according to the present invention is not limited to a type which is used in a cellular phone. The input device of the present invention may be used in other appliances or apparatus employing touch panels, such as digital cameras, and personal navigation devices, automatic teller machines, for example.

1. An input device comprising:
a base plate including a front surface and a rear surface;
a plurality of first electrodes formed on the front surface of the base plate and parallel to each other, each of the first electrodes including a plurality of first electrode elements arranged in a first direction;
a plurality of second electrodes formed on the front surface of the base plate and parallel to each other, each of the second electrodes including a plurality of second electrode elements arranged in a second direction different from the first direction;
a controller for detection of a conductor approaching the first electrodes and the second electrodes in a thickness direction of the base plate, the controller being configured to detect an access position of the conductor with respect to the first direction and the second direction based on a capacitance change in the first electrodes and the second electrodes; and
a plurality of first wiring elements each connecting the first electrode elements of a corresponding one of the first electrodes;
wherein one of the first wiring elements is formed in a first gap flanked by adjacent ones of the first electrode elements and the second electrode elements.

2. The input device according to claim 1, further comprising a plurality of second wiring elements each connecting the second electrode elements of a corresponding one of the second electrodes, wherein the second wiring elements connect adjacent ones of the second electrode elements and are formed in portions flanked by the second electrode elements.

3. The input device according to claim 1, wherein the first wiring elements extend onto a non-detection region provided other than a detection region on the base plate arranged for detection of access of the conductor.

4. The input device according to claim 3, wherein the first electrode elements include two electrode elements arranged in the second direction, the first wiring elements include two wiring elements extending from the two electrode elements, respectively, and the two wiring elements extend oppositely of each other in the second direction.

5. The input device according to claim 4, wherein one of the two electrode elements of the first electrode elements is closer to an end of the detection region in the second direction than the other one of the two electrode elements of the first electrode elements is, and the first wiring element extending from said one of the two electrode elements of the first electrode elements extends toward the end of the detection region.

6. The input device according to claim 3, wherein the first wiring elements include wiring elements formed in the non-detection region and made of a metal.

7. The input device according to claim 3, wherein the first wiring elements are connected to each other in the non-detection region.

8. The input device according to claim 1, further comprising a multilayer substrate supported by the base plate, wherein the first wiring elements are connected to each other on the multiplayer substrate.

9. The input device according to claim 1, wherein the first wiring elements include first connection elements connecting adjacent ones of the first electrode elements in the first direction and formed in gaps between the adjacent ones of the first electrode elements, and the first wiring elements further include wiring elements that are connected to the adjacent ones of the first electrode elements or to the first connection elements and that extend in the second direction onto the non-detection region.

10. The input device according to claim 9, wherein the second wiring elements include wiring elements each of which connects two adjacent ones of the second electrode elements flanking one of the first connection elements and is arranged to skirt around one of the first electrode elements connected to the first connection elements, said one of the first electrode elements being disposed at an end.

11. The input device according to claim 9, wherein the first electrode elements connected by the first connection elements comprise only two first electrode elements.

12. The input device according to claim 1, wherein the first wiring elements include a wiring element connecting ones of the first electrode elements that are adjacent in the first direction and contained in one of the first electrodes, and said wiring element is formed in a second gap flanked by ones of the second electrode elements that are adjacent in the second direction and contained in one of the second electrodes.

13. The input device according to claim 12, further comprising a plurality of second wiring elements each connecting the second electrode elements constituting one of the second electrodes, wherein in the second electrode containing the two second electrode elements flanking the second gap, adjacent ones of the second electrode elements are connected to each other by the second wiring elements except for the two second electrode elements flanking the second gap.

14. The input device according to claim 12, wherein the second wiring elements include wiring elements arranged to extend from the second electrode elements contained in one of the second electrodes that is closest to an end, in the first direction, of the detection region for detecting access of the conductor, and arranged to extend in the first direction to said end of the detection region.

15. The input device according to claim 14, wherein the plurality of first electrodes include a first electrode traversing the detection region in the first direction, a plurality of second gaps are arranged in the first direction, and the first electrode traversing the detection region comprises first electrode elements, adjacent ones of which are arranged to flank one of the second gaps.

16. The input device according to claim 15, wherein part of the first wiring elements extending from the first electrode elements constituting one of the first electrodes that is adjacent, in the second direction, to the first electrode traversing the detection region, is formed in the second gaps.

17. The input device according to claim 14, wherein the wiring elements of the second wiring elements extending to said end of the detection region are connected to each other in a non-detection region provided other than the detection region on the base plate, and the second wiring elements include wiring elements formed in the non-detection region and made of metal.

18. The input device according to claim 12, wherein the first wiring elements include wiring elements arranged to extend from the first electrode elements contained in one of the first electrodes that is closest to an end, in the second direction, of the detection region for detecting access of the conductor, and arranged to extend in the second direction to said end of the detection region.

19. The input device according to claim 1, wherein the first wiring elements and the second wiring elements include wiring elements formed in a non-detection region provided other than a detection region on the base plate for detection of access of the conductor, said wiring elements of the first wiring elements and the second wiring elements are stacked with an insulating layer intervening therebetween.

20. The input device according to claim 19, wherein one of the stacked wiring elements is closer to the base plate and made of a same material used for making the first electrodes or the second electrodes.

21. The input device according to claim 19, wherein one of the stacked wiring elements is opposite to the base plate with respect to the insulating layer and made of metal.

22. An input device comprising:
a base plate including a front surface and a rear surface;
a plurality of first electrodes formed on the front surface of the base plate and parallel to each other, each of the first electrodes including a plurality of first electrode elements arranged in a first direction;
a plurality of second electrodes formed on the front surface of the base plate and parallel to each other, each of the second electrodes including a plurality of second electrode elements arranged in a second direction different from the first direction;
a controller for detection of a conductor approaching the first electrodes and the second electrodes in a thickness direction of the base plate, the controller being configured to detect an access position of the conductor with respect to the first direction and the second direction based on a capacitance change in the first electrodes and the second electrodes;
a plurality of first wiring elements each connecting the first electrode elements of a corresponding one of the first electrode; and
a plurality of second wiring elements each connecting the second electrode elements of a corresponding one of the second electrodes;
wherein the second wiring elements are stacked on the first wiring elements or the first electrodes with an insulating layer intervening therebetween, and the second wiring elements include connecting portions provided on the second electrode elements and extending in the second direction.

23. The input device according to claim 22, wherein the second wiring elements include two wiring elements for connecting one second electrode element provided with a connecting portion, to two second electrode elements adjacent to said one second element, and said two wiring elements are connected to each other.

24. The input device according to claim 23, wherein the insulating layer covers part of the second electrodes and is formed with openings corresponding in position to the connecting portions.

25. The input device according to claim 24, each of the connecting portions extends in the second direction from one end to the opposite end of a corresponding one of the openings.

26. The input device according to claim 22, wherein the insulating layer entirely covers the first electrodes and the first wiring elements formed in the detection region for detecting access of the conductor.

27. The input device according to claim 26, further comprising peripheral wiring connected to the first electrode elements and the controller and formed in a non-detection region provided other than the detection region on the base plate, wherein the peripheral wiring and the second wiring elements extend in the second direction and made of a same material.

28. The input device according to claim 27, wherein the same material is metal or a transparent conductive material.

29. An input device comprising:
a base plate including a front surface and a rear surface;
a plurality of first electrodes formed on the front surface of the base plate and parallel to each other, each of the first electrodes including a plurality of first electrode elements arranged in a first direction;
a plurality of second electrodes formed on the front surface of the base plate and parallel to each other, each of the second electrodes including a plurality of second electrode elements arranged in a second direction different from the first direction;
a controller for detection of a conductor approaching the first electrodes and the second electrodes in a thickness direction of the base plate, the controller being configured to detect an access position of the conductor with respect to the first direction and the second direction based on a capacitance change in the first electrodes and the second electrodes;
first wiring made of a metal and connecting two adjacent ones of the first electrode elements in the first direction and formed in gaps between the first electrode elements; and
second wiring stacked on the first wiring at a side opposite to the base plate and connecting two adjacent ones of the second electrode elements in the second direction, the second wiring being formed in gaps between the second electrode elements.

30. The input device according to claim 29, wherein the second wiring is made of a metal.

31. The input device according to claim 29, wherein the first wiring and the second wiring are made of a transparent conductive material.
